(19) United States
(12) Patent Application Publication
(10) Pub. No.: US 2010/0290824 A1
(43) Pub. Date: Nov. 18, 2010

(54) IMAGE FORMING APPARATUS

(76) Inventors: Keisuke Tanaka, Chiba (JP); Shinichi Kawabata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/810,829

(22) PCT Filed: Jul. 9, 2009
(86) PCT No.: PCT/JP2009/062514

§ 371 Date: Jun. 25, 2010

(30) Foreign Application Priority Data
Jul. 25, 2008 (JP) 2008-192018 2008

(51) Int. Cl. G03G 21/10

(52) U.S. Cl. 399/359

(57) ABSTRACT

The image forming apparatus includes plurality of image forming units having photosensitive elements; a plurality of toner containers, cleaning units for removing the toner left on the photosensitive elements, a waste toner recovering container for accumulating the waste toners removed from the photosensitive elements, and waste toner transfer passages connecting the cleaning units and the waste toner recovering container, for transferring the waste toners to the waste toner recovering container. The waste toner transfer passages, which is formed in the image forming unit using the toner container of the largest capacity, for transferring the waste toners in the cleaning units, is to be longest.

### TECHNICAL FIELD

The present invention relates to an image forming apparatus having a plurality of image forming units having a photoreceptor, and a waste toner recovery container, which conveys and accumulates waste toners recovered at cleaning units disposed at each of the aforesaid image forming units.

### BACKGROUND TECHNOLOGY

Heretofore, there has been widely used an image forming apparatus, in which light is irradiated on a charged photoreceptor based on image data, and a toner is attracted on the photoreceptor, after which, the toner is transferred to a sheet of paper, and then, the toner is fixed. The image forming apparatus, which forms an image using a toner, is arranged so that it has in general a waste toner recovery container, and an unnecessary toner remaining on the photoreceptor after the image was transferred is removed at a cleaning unit, and then, the toner is transferred through waste toner transfer passages to be accumulated in the waste toner recovery container.

As such a waste toner recovery container, there has been known a container, in which a plurality of waste toner discharge openings or a waste toner discharge opening having a single continuous long opening are arranged at a waste toner transfer passage, and, at the opposite place, an opening of the waste toner recovery container is arranged (refer, for example, to Patent Document 1).

### PRIOR ARTS

### Patent Document

Patent Document 1: Japanese Patent Application No. H5-165381

### SUMMARY OF THE INVENTION

### Issues to be Solved by the Invention

There has been a color image forming apparatus, which is provided with image forming units containing a plurality of photoreceptors corresponding to each of black (K), yellow (Y), magenta (M), and cyan (C) images, and forms a color image by superimposing each of the colored toner images on an intermediate transfer body.

In an image forming apparatus provided with a plurality of photoreceptors corresponding to each of the colors such as described above, there has been the following problem in case of a constitution where toners removed from each of the photoreceptors are transferred while collecting them through the same waste toner transfer passage to accumulate them in a waste toner recovery container.

In case of most of the color image forming apparatuses, each amount of toner used for each color generally differs from each other. For a frequently used color, a capacious container of toner is used, and from a cleaning unit of a photoreceptor, in which a larger amount of toner is used, a larger amount of waste toner is generated. The waste toner generated from a photoreceptor using a large amount of toner is likely to become lumpy because the amount is large, resulting in a case where the waste toner clogs in waste toner transfer passages.

Even if the lumpy waste toner passes through waste toner transfer passages to be accumulated in a waste toner recovery container, the accumulation characteristic performance of the toner in the container is inefficient, resulting in an ineffective usage of the capacity of the waste toner recovery container.

The present invention has been achieved in consideration of the above problems, and it is an object of this invention to provide an image forming apparatus, which can be clog-free in waste toner transfer passages and have a high accumulation characteristic performance in the waste toner recovery container, and can make more effective use of the capacity of the waste toner recovery container, even if the structure of the image forming apparatus is so constituted as to include a plurality of image forming units having photosensitive elements and to gather and transfer the toners removed from the individual photosensitive element, thereby accumulating the toners in a waste toner recovery container.

### MEASURES TO SOLVE THE ISSUES

The above object can be achieved by the invention described below.

(1) An image forming apparatus comprising a plurality of image forming units having a photoreceptor; a plurality of toner containers containing toners to supply them to each of the aforesaid image forming apparatus; a plurality of cleaning units being disposed at each of the above image forming units and to remove toners remaining on the above photoreceptor after an image was transferred; a waste toner recovery container to accumulate the waste toners removed from the above photoreceptor by the aforesaid cleaning units; and waste toner transfer passages to connect the above cleaning units and the above waste toner recovery container, and to transfer the waste toners removed at the above cleaning units to the above waste toner recovery container, whereby, among the above waste toner transfer passages, the longest one is a waste toner transfer passage to transfer the waste toners at a cleaning unit of the image forming unit using a toner container having the largest capacity.

(2) An image forming apparatus comprising a plurality of image forming units having a photoreceptor; a plurality of toner containers containing toners to supply them to each of the aforesaid image forming apparatus; a plurality of cleaning units being disposed at each of the above image forming units and to remove toners remaining on the above photoreceptor after an image was transferred; a waste toner recovery container to accumulate the waste toners removed from the above photoreceptor by the aforesaid cleaning units; and waste toner transfer passages to connect the above cleaning units and the above waste toner recovery container, and to transfer the waste toners removed at the above cleaning units to the above waste toner recovery container, whereby one of the above plurality of toner containers is a container containing black toner, and among the above waste toner transfer passages, the longest one is a waste toner transfer passage to transfer the waste toners at a cleaning unit of the image forming unit using a toner container containing black toner.

(3) The image forming apparatus described in the above (1), whereby the above waste toner transfer passages are connected to the above plurality of cleaning units.

(4) The image forming apparatus described in the above (1), whereby the above waste toner transfer passages are provided with a waste toner transfer member, which is equipped with a screw section and a shaft, and gaps are formed between the aforesaid screw section and the aforesaid shaft

(5) The image forming apparatus described in the above (1), whereby the above toner container having the largest capacity contains black toner.

### EFFECTS OF THE INVENTION

According to the present invention, it is possible to obtain an image forming apparatus, which can be clog-free in waste toner transfer passages and have a high accumulation characteristic performance in the waste toner recovery container, and can make effective use of the capacity of the waste toner recovery container, even if the structure of the image forming apparatus is so constituted as to include a plurality of image forming units having photosensitive elements and to gather and transfer the toners removed from the individual photosensitive element, whereby accumulating the toners in a waste toner recovery container.

### BRIEF DESCRIPTION OF THE DRAWINGS

FIG. 1 is a cross section showing an entire constitution of the image forming apparatus relating to the first embodiment.

FIG. 2 is a schematic depiction showing cleaning units, a waste toner recovery container, and waste toner transfer passages of the image forming apparatus relating to the first embodiment.

FIG. 3 is a figure showing a waste toner transfer member arranged interior of the waste toner transfer passages.

FIG. 4 is a figure showing an example of the waste toner transfer member arranged interior of the waste toner transfer passages.

FIG. 5 is a cross section showing an entire constitution of the image forming apparatus relating to the second embodiment.

FIG. 6 is a schematic depiction showing cleaning units, a waste toner recovery container, and waste toner transfer passages of the image forming apparatus relating to the second embodiment.

### BEST MODES FOR CARRYING OUT THE INVENTION

The present invention is described in detail below with reference to embodiments, but the invention is not limited to them.

### First Embodiment

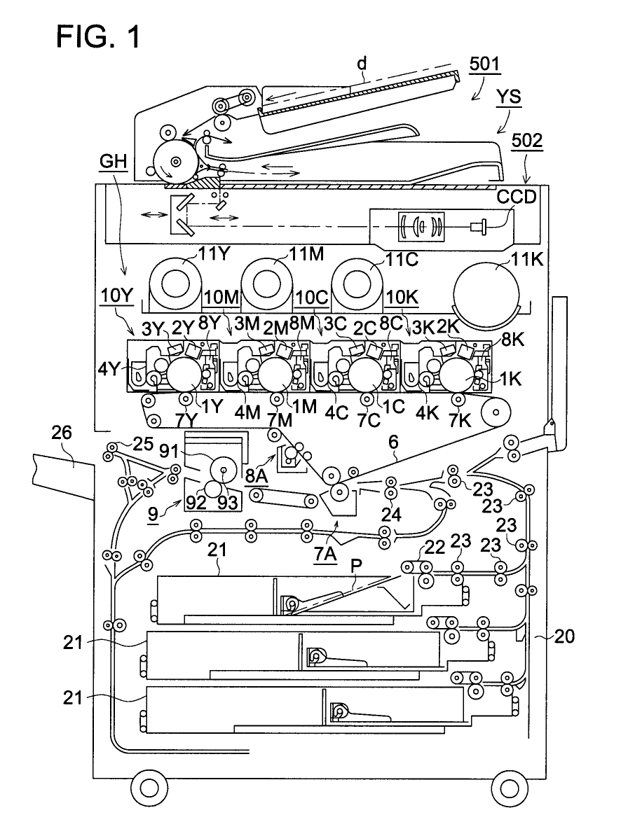

FIG. 1 is a cross section showing the entire constitution of the image forming apparatus relating to the first embodiment.

The image forming apparatus, as shown in the above figure, is constituted of an image forming section GH, an image reading apparatus YS, a fixing apparatus 9, and the like. The image forming section GH is called a tandem type color image forming section, and is constituted of a plurality of pairs of image forming units 10Y, 10M, 10C, and 10K, an intermediate transfer body 6, a secondary transfer section 7A, and the like.

In the upper part of the image forming section GH, there is arranged the image reading apparatus YS composed of an automatic document feeding apparatus 501, and a scanning exposure apparatus 502. A document d placed on a document table of the automatic document feeding apparatus 501 is fed by a feeding section, and an image on one side or images on both sides of the document are scanning exposed by an optical system of the scanning exposure apparatus 502 to be read in a line sensor CCD.

An image signal photoelectrically converted by the line sensor is subjected, at an image processing section, to an analogue processing, an A/D conversion, a shading compensation, an image compression processing, and the like, after which the image signal is sent to exposure units 3Y, 3M, 3C, and 3K.

The image forming unit 10 Y, which forms a yellow (Y) image, has a charging unit 2Y, an exposure unit 3Y, a developing apparatus 4Y, a primary transfer section 7Y, and a cleaning unit 8Y around a photoreceptor drum 1Y, which forms an image carrying body.

The image forming unit 10 M, which forms a magenta (M) image, has a charging unit 2M, an exposure unit 3M, a developing apparatus 4M, a primary transfer section 7M, and a cleaning unit 8M around a photoreceptor drum 1M.

The image forming unit 10 C, which forms a cyan (C) image, has a charging unit 2C, an exposure unit 3C, a developing apparatus 4C, a primary transfer section 7C, and a cleaning unit 8C around a photoreceptor drum 1C.

The image forming unit 10K, which forms a black (K) image, has a charging unit 2K, an exposure unit 3K, a developing apparatus 4K, a primary transfer section 7K, and a cleaning unit 8K around a photoreceptor drum 1K.

Each of the pairs of the charging unit 2Y and the exposure unit 3Y, the charging unit 2M and the exposure unit 3M, the charging unit 2C and the exposure unit 3C, and the charging unit 2K and the exposure unit 3K constitutes a latent image forming section.

The developing apparatuses 4Y, 4M, 4C, and 4K of the image forming apparatus relating to the present embodiment use a two-component developer composed of minute toner particles of, for example, yellow (Y), magenta (M), cyan (C), and black (K), and carriers, but may use a single-component developer.

In the image forming unit 10Y, the photoreceptor drum 1Y is charged by the charging unit 2Y, light is irradiated on the drum by the exposure unit 3Y based on image data, and toner is attracted to the resulting drum by developing apparatus 4Y, after which a yellow (Y) image is primary transferred onto the intermediate transfer body 6. The toner remaining on the photoreceptor drum 1Y after the image was primary transferred onto the intermediate transfer body 6 is removed by the cleaning unit 8Y.

Also in the image forming units 10M, 10C, and 10K, in a similar manner for each unit, the photoreceptor drums 1M, 1C, and 1K are charged by the charging units 2M, 2C, and 2K, respectively, which drums are irradiated by the light by the exposure units 3M, 3C, and 3K, respectively based on each of image data, and toner is attracted to the resulting drums by developing apparatuses 4M, 4C, and 4K, after which the image of each color is primary transferred onto the intermediate transfer body 6. The toner remaining on each of the photoreceptor drums 1M, 1C, and 1K after the image was primary transferred onto the intermediate transfer body 6 is removed by each of the cleaning units 8M, 8C, and 8K.

The intermediate transfer body 6 is wound about and rotatably supported by a plurality of rollers. The fixing apparatus 9 is equipped with a fixing roller 91 and a pressing roller 92, and a toner image on a sheet P is fixed by heating and pressing at a nip portion formed between the fixing roller 91 and the pressure roller 92.

The image of each color formed by the image forming units 10Y, 10M, 10C, and 10K is successively primary transferred and superimposed by the primary transfer sections 7Y, 7M, 7C, and 7K on the rotating intermediate transfer body 6, whereby a color image is formed.

The sheets P stored in a sheet feed tray 21, which is a sheet storing section, are separated sheet by sheet by a sheet feed roller 22 of a sheet feed section 20 and drawn out, and then, the sheets are fed, through a sheet feeding roller 23, to a registration roller 24, which is in an idle state. The sheet P once stops there, and by starting the registration roller to rotate at just the right moment when the position relationship between the leading edge of the sheet P and the toner image on the intermediate transfer body 6 matches with each other, the sheet P is fed to the secondary transfer section 7A, and then, a color image is secondary transferred onto the sheet P. The sheet P, onto which the color image has been transferred, is heated and pressed at the fixing apparatus 9, whereby the color image is fixed on the sheet P. After that, the sheet P is nipped by sheet discharge rollers 25, and then, placed on a sheet discharge tray, which is attached to the outside of the image forming apparatus.

The residual toners remaining on the intermediate transfer body 6, from which the sheet P has been separated due to different radii of curvature after the color image has been transferred onto the sheet P by the secondary transfer section 7A, are removed by an intermediate transfer body cleaning unit 8A.

A toner container 11Y stores a yellow (Y) toner, and supplies the toner to the developing apparatus 4Y, a toner container 11M stores a magenta (M) toner, and supplies the toner to the developing apparatus 4M, a toner container 11C stores a cyan (C) toner, and supplies the toner to the developing apparatus 4C, and a toner container 11K stores a black (K) toner, and supplies the toner to the developing apparatus 4K.

As shown in the figure, for the toner container 11K storing the most frequently used black (K) toner, a toner container having the largest capacity is used.

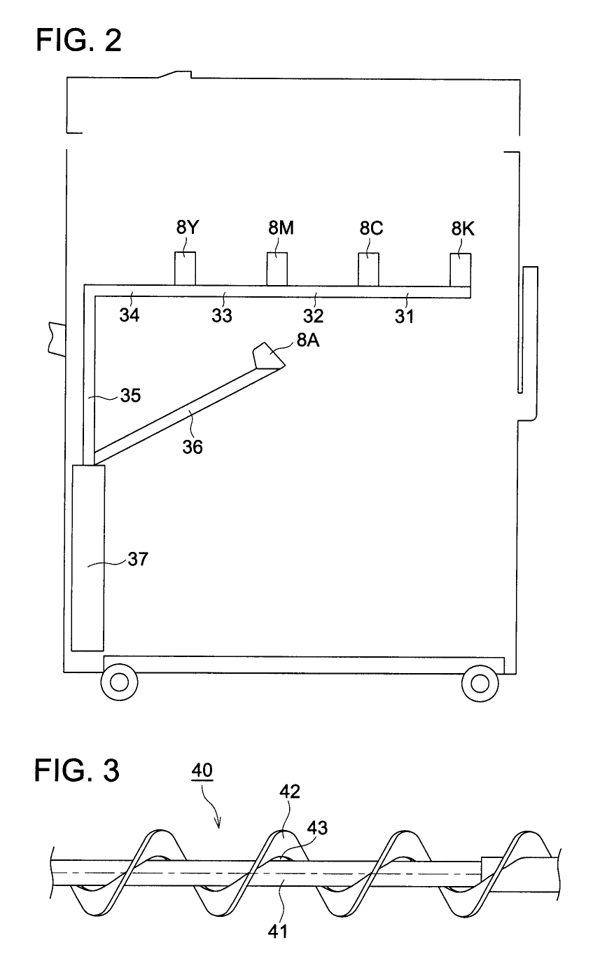

FIG. 2 is a schematic depiction showing cleaning units, a waste toner recovery container, and waste toner transfer passages of the image forming apparatus relating to the first embodiment.

As shown in FIG. 2, the waste toner removed at each of the cleaning units 8K, 8C, 8M, and 8Y, which removes residual toner remaining on each of the photoreceptors, is transferred in the left direction of the figure through waste toner transfer passages 31 to 34 formed in a nearly horizontal direction. The waste toner transfer passages 31 to 34 are made by connecting tubular pipe sections continuously, and the waste toner transfer member (not illustrated), which transfers waste toners in the left direction of the figure, is disposed interior of the passages, and are arranged so that the waste toner transfer member rotates by a drive unit (not illustrated).

With the above configuration, in the waste toner transfer passage 31, the waste toner transfer passage 32, the waste toner transfer passage 33, and the waste toner transfer passage 34, the black toner, a mixture of the black and cyan toners, a mixture of the black, cyan, and magenta toners, and a mixture of the black, cyan, magenta, and yellow toners are transferred respectively.

The waste toner transfer passage 34 is connected with a waste toner transfer passage 35, which is formed in the nearly vertical direction, and a black waste toner together with the waste toners of the above-described three colors are accumulated in a waste toner recovery container 37 through the waste toner transfer passage 35. The waste toner transfer passage 35 is also formed with tubular pipe sections, and the waste toner transfer member (not illustrated), which transfers waste toners in the downward direction of the figure, is disposed interior of the passages, and are arranged so that the waste toner transfer member rotates by a drive unit (not illustrated).

Namely, as shown in the figure, the waste toner transfer passages, which connect each of the cleaning units arranged at each of the photoreceptors with the waste toner recovery container 37, have the passages (34 and 35) of the yellow waste toner from the cleaning unit 8Y, the passages (33, 34 and 35) of the magenta waste toner from the cleaning unit 8M, the passages (32, 33, 34 and 35) of the cyan waste toner from the cleaning unit 8C, and the passages (31, 32, 33, 34 and 35) of the black waste toner from the cleaning unit 8K. It is assembled so that, among the waste toner transfer passages connected with the cleaning units corresponding to each of the colors, the longest one is the waste toner transfer passages (31, 32, 33, 34 and 35) connected with the cleaning unit 8K arranged at the photoreceptor, which uses a toner contained in the black toner container 11K having the largest capacity, compared with the waste toner transfer passages connected with the cleaning units for the other colors.

As described above, among the waste toner transfer passages connecting each of the cleaning units arranged at each of the image forming units of the primary transfer section with the waste toner recovery container, the waste toner transfer passages of the photoreceptor of the image forming unit arranged at the black toner container having the largest capacity, are formed so that the passages are the longest, whereby the contact time of the black waste toner having a lot of discharge amount of toner with the waste toner transfer member can be made longest. By lengthening the contact time of the black waste toner having a lot of discharge amount of toner with the waste toner transfer member, a lot of the time to break up a lump of toner can be secured, to solve a problem of clogging at the waste toner transfer passages, and further, it becomes possible to improve accumulation characteristic performance of the waste toner recovery container.

The waste toner removed at the intermediate transfer body cleaning unit 8A is transferred, through a waste toner transfer passage 36 differing from the waste toner transfer passages 31 to 35, to the waste toner recovery container 37 to be accumulated.

FIG. 3 is a figure showing the waste toner transfer member 40 arranged interior of the waste toner transfer passages 31 to 34 and 36.

As shown in FIG. 3, the waste toner transfer member 40 arranged interior of the waste toner transfer passages 31 to 34 and 36 is equipped with the screw section 42 and the shaft 41. And gaps 43 are formed between the screw section 42 and the shaft 41. The screw section 42 is integrated with the shaft 41 at the both ends thereof. With this configuration, it is arranged so that, by allowing the shaft 41 to rotate by a drive unit (not illustrated), the screw 42 is allowed to rotate, whereby the waste toner is transferred.

As described above, by using the waste toner transfer member, in which gaps 43 are formed between the screw section 42 and the shaft 41 as a waste toner transfer member in the waste toner transfer passages 31 to 34 and 36 formed in the near horizontal direction, it becomes possible to break up the lump of waste toner more effectively.

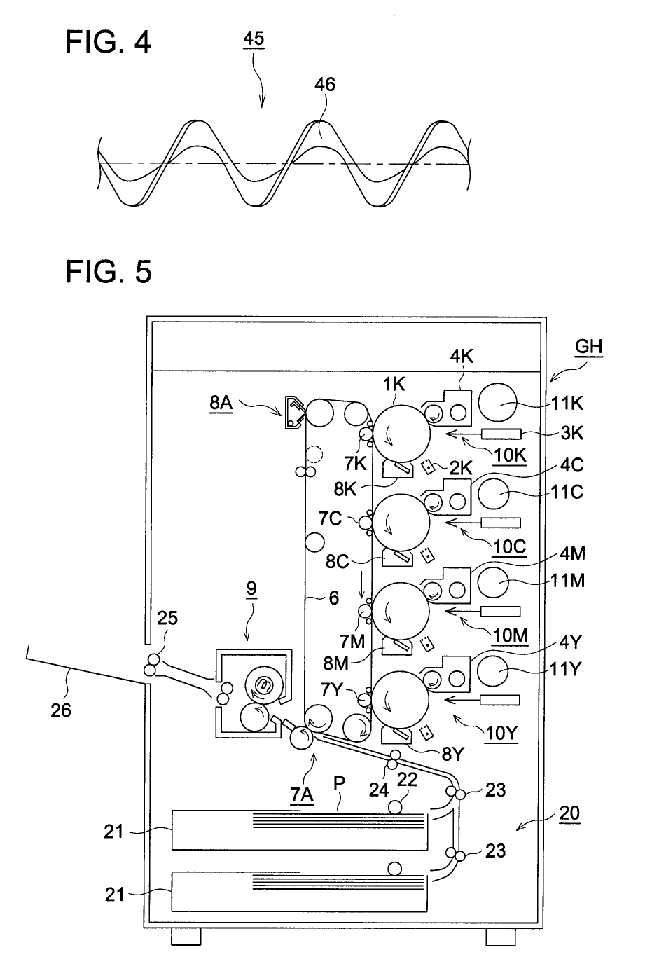

FIG. 4 is a figure showing an example of a waste toner transfer member 45 arranged interior of the waste toner transfer passage 35.

The waste toner transfer member 45 arranged interior of the waste toner transfer passage 35 formed in the near vertical direction may be the one described below other than the one described in FIG. 3, in which gaps 43 are formed between the screw section 42 and the shaft 41. Namely, as shown in FIG. 4, the waste toner transfer member 45 may be constituted only of a coiled screw section 46.

### Second Embodiment

FIG. 5 is a cross section showing an entire constitution of the image forming apparatus relating to the second embodiment.

The image forming apparatus shown in FIG. 5 is the one, in which the image forming units 10K, 10Y, 10M, and 10C constituting the image forming section GH of the image foaming apparatus shown in FIG. 1, are arranged lengthwise. Since each of the image forming units, the intermediate transfer body 6, the secondary transfer section 7A, and the like are the same as those shown in FIG. 1, the same reference numerals denote the same functional members. Therefore, their descriptions will be omitted, and only the image forming unit 10K will be described.

In the image forming unit 10K, the photoreceptor drum 1K is charged by the charging unit 2K, which drum is irradiated by the light by the exposure unit 3K based on image data, and a toner is attracted to the resulting drum by the developing apparatus 4K, after which, at the primary transfer section 7K, the black image is transferred onto the intermediate transfer body 6. The toner remaining on the photoreceptor drum 1K after the image was transferred onto the intermediate transfer body 6 is removed by the cleaning unit 8K.

Similarly, images of each color formed by each of the image forming units 10Y, 10M, and 10C are successively transferred and combined into one on the rotating intermediate transfer body 6 by the primary transfer sections 7Y, 7M, and 7C, whereby a color image is formed. Each of the residual toners remaining on each of the photoreceptor drums after each of the toners was primary transferred onto the intermediate transfer body 6 is removed by each of cleaning units 8C, 8M, and 8Y.

The sheets P stored in the sheet feed tray 21, which is a sheet storing section, are separated sheet by sheet by the sheet feed roller 22 of the sheet feed section 20 and drawn out, and then, the sheets are fed, through the sheet feeding roller 23, to the registration roller 24, which is in an idle state. The sheet P once stops there, and by starting the registration roller to rotate at just the right moment when a position relationship between the sheet P and the toner image on the intermediate transfer body 6 matches with each other, the sheet P is fed to the secondary transfer section 7A, and then, a color image is transferred onto the sheet P (the secondary transfer). The sheet P, onto which the color image has been transferred, is heated and pressed at the fixing apparatus 9, whereby the color image is fixed on the sheet P. After that, the sheet P is nipped by sheet discharge milers 25, and then, placed on a sheet discharge tray, which is attached to the outside of the image forming apparatus.

The residual toners remaining on the intermediate transfer body 6 are removed by the intermediate transfer body cleaning unit 8A.

The toner container 11Y stores a yellow (Y) toner, the toner container 11M stores a magenta (M) toner, the toner container 11C stores a cyan (C) toner, and the toner container 11K stores a black (K) toner, each of which supplies each of the toners to the developing apparatuses 4Y, 4M, and 4C, respectively.

As shown in the figure, for the toner container 11K storing the most frequently used black (K) toner, a toner container having the largest capacity is used.

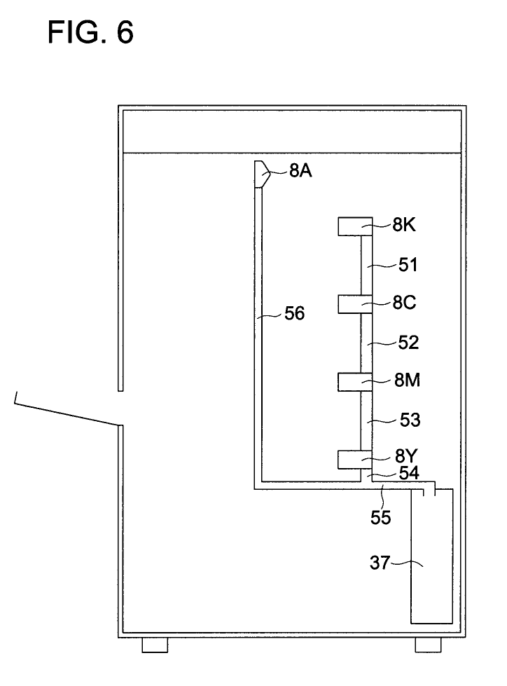

FIG. 6 is a schematic depiction showing cleaning units, a waste toner recovery container, and waste toner transfer passages of the image forming apparatus relating to the second embodiment.

As shown in FIG. 6, the waste toners removed at each of the cleaning units 8K, 8C, 8M, and 8Y, which removes residual toners remaining on each of the photoreceptors, are transferred in the downward direction of the figure through waste toner transfer passages 51 to 54 formed in a nearly vertical direction. The waste toner transfer passages 51 to 54 are made by connecting tubular pipe sections continuously, and the waste toner transfer member (not illustrated), which transfers waste toners in the downward direction of the figure, is disposed interior of the passages, and are arranged so that the waste toner transfer member rotates by a drive unit (not illustrated).

With the above configuration, in the waste toner transfer passage 51, a waste toner transfer passage 52, the waste toner transfer passage 53, and the waste toner transfer passage 54, the black toner, a mixture of the black and cyan toners, a mixture of the black, cyan, and magenta toners, and a mixture of the black, cyan, magenta, and yellow toners are transferred respectively.

The waste toner transfer passage 54 is connected with a waste toner transfer passage 55, which is formed in the nearly horizontal direction, and a black waste toner together with the waste toners of the above-described three colors are accumulated in the waste toner recovery container 37 through the waste toner transfer passage 55. The waste toner transfer passage 55 is also formed with tubular pipe sections, and the waste toner transfer member (not illustrated), which transfers waste toners, is disposed interior of the passages, and are arranged so that the waste toner transfer member rotates by a drive unit (not illustrated).

Namely, as shown in the figure, the waste toner transfer passages, which connect each of the cleaning units arranged at each of the photoreceptors with the waste toner recovery container, have the passages (54 and 55) of the yellow waste toner from the cleaning unit, the passages (53, 54 and 55) of the magenta waste toner from the cleaning unit, the passages (52, 53, 54 and 55) of the cyan waste toner from the cleaning unit, and the passages (51, 52, 53, 54 and 55) of the black waste toner from the cleaning unit. It is assembled so that, among the waste toner transfer passages connected with the cleaning units corresponding to each of colors, the longest one is the waste toner transfer passages (51, 52, 53, 54 and 55) connected with the cleaning unit arranged at the photoreceptor, which uses a toner contained in the black toner container having the largest capacity, compared with the waste toner transfer passages connected with the cleaning units for the other colors.

As described above, among the waste toner transfer passages connecting each of the cleaning units arranged at each of the image forming units of the primary transfer section with the waste toner recovery container, the waste toner transfer passages of the photoreceptor of the image forming unit arranged at the black toner container having the largest capacity, are formed so that the passages are the longest, whereby the contact time of the black waste toner having a lot of discharge amount of toner with the waste toner transfer member can be made longest. By lengthening the contact time of the black waste toner having a lot of discharge amount of toner with the waste toner transfer member, a lot of the time to break up a lump of toner can be secured, to solve a problem of clogging at the waste toner transfer passages, and further, it becomes possible to improve accumulation characteristic performance of the waste toner recovery container.

The waste toner transfer member disposed interior of the transfer passages 51 to 54 formed in the near vertical direction shown in FIG. 6 is preferably a member, in which gaps 43 are formed between the screw section 42 and the shaft 41 shown in FIG. 3, or a member, which is constituted only of a coiled screw section 46 as shown in FIG. 4. Also it is preferable that the waste toner transfer member disposed interior of the transfer passage 55 is a member, in which gaps 43 are formed between the screw section 42 and the shaft 41 shown in FIG. 3.

In the above embodiment, described was an example using a toner container having the largest capacity storing black toner, but it is not limited to that. In case where the most frequently used color is another color, it may be formed so that the capacity of that toner container, having the aforesaid most frequently used color, is the highest, and the waste toner transfer passage, which transfers the waste toner in the cleaning unit in the image forming unit using the aforesaid toner container, is made longest.

Further, in the above embodiment, described was an example using an image forming apparatus having toner containers differing in the capacity. However, in case where the image forming apparatus uses the toner containers, all of which have the same capacity, it may be formed so that the length of the waste toner transfer passage, which transfers the waste toner in the cleaning unit in the image forming unit using the toner container storing black toner, the color of which is, in general, most frequently used, is made longest.

Furthermore, in the above embodiment, described was an example using a waste toner transfer passage formed by connecting each of the waste toner transfer passages of each of the cleaning units arranged at each of the photoreceptors, but it is not limited to that and it may be a structure that a transfer passage of a specific cleaning unit is constituted so as to follow a route differing from other passages. Also, it was described using a constitution that the waste toner transfer passages are accumulated to one piece of the waste toner recovery container, but it is not limited to it, and it may be a constitution having a plurality of waste toner recovery containers.

### DESCRIPTION OF ALPHANUMERIC DESIGNATIONS

6: an intermediate transfer body
8Y, 8M, 8C, and 8K: a cleaning unit
9: a fixing apparatus
10Y, 10M, 10C, and 10K: an image forming unit
11Y, 11M, 11C, and 11K: a toner container
31, 32, 33, 34, and 35: a waste toner transfer passage
37: a waste toner recovery container
40, and 45: a waste toner transfer member
51, 52, 53, 54, and 55: a waste toner transfer passage

1. An image forming apparatus comprising:
a plurality of image forming units, each of which includes a photoreceptor;
a plurality of toner containers containing toner to supply the toner to each of the image forming units;
a plurality of cleaning units each of which is disposed at each of the image forming units to remove toner remaining after transferring image on the photoreceptor;
a waste toner recovery container to accumulate waste toner removed from the photoreceptors by the cleaning units; and;
waste toner transfer passages to connect the cleaning units and the waste toner recovery container and to transfer the waste toner removed by the cleaning units to the waste toner recovery container,
wherein a waste toner transfer passage to transfer the waste toners at a cleaning unit of an image forming unit using a toner container having a largest capacity is a longest waste toner transfer passage among the waste toner transfer passages.

2. An image forming apparatus comprising:
a plurality of image forming units, each which includes a photoreceptor;
a plurality of toner containers, each of which contains toner to supply toner to each of the image forming units;
a plurality of cleaning units each of which is disposed at each of the image forming units to remove toner remaining after image transfer on the photoreceptor;
a waste toner recovery container to accumulate waste toner removed from the photoreceptor by the cleaning units; and
waste toner transfer passages to connect the cleaning units and the waste toner recovery container and to transfer the waste toners removed by the cleaning units to the waste toner recovery container,
wherein one of the plurality of toner containers is a container to contain black toner and a waste toner transfer passage to transfer the waste toner at a cleaning unit of the image forming unit using the toner container to contain black toner is a longest waste toner transfer passage among the waste toner transfer passages.

3. The image forming apparatus described in claim 1, wherein the waste toner transfer passages are connected to the plurality of cleaning units.

4. The image forming apparatus described in claim 1, wherein the waste toner transfer passages are provided with a waste toner transfer member, wherein the waist toner transfer member is equipped with a screw section and a shaft, wherein a gap is formed between the screw section and the shaft.

5. The image forming apparatus described in claim 1, wherein a toner container having a largest capacity contains black toner.
